(19) United States
(12) Patent Application Publication
(10) Pub. No.: US 2022/0180383 A1
(43) Pub. Date: Jun. 9, 2022

(54) WATER HEATER WITH ELECTRONIC MIXING VALVE AND AUTOMATIC SET POINT

(71) Applicant: Haier US Appliance Solutions, Inc., Wilmington, DE (US)

(72) Inventor: Sukumar Arrojula, Louisville, KY (US)

(21) Appl. No.: 17/115,262

(22) Filed: Dec. 8, 2020

(51) Int. Cl. G06Q 30/02; F24D 19/10; F24H 7/00; F24H 9/12; G05D 23/19

(52) U.S. Cl. CPC G06Q 30/0202; F24D 19/1051; G05D 23/19; F24H 9/124; F24H 7/00

(57) ABSTRACT

A water heater and methods of operating the water heater are provided. The water heater appliance includes a tank, a cold water inlet conduit extending into the tank, a heating element within the tank, a hot water conduit extending from the tank to a mixing valve, a mixed water conduit downstream of the mixing valve, and a user interface. The method includes and/or the water heater is operable for receiving, from the user interface, a user value for a tank temperature setpoint. A predicted demand for hot water is determined. The tank temperature setpoint is then adjusted based on the predicted demand for hot water.

### FIELD OF THE INVENTION

The present disclosure relates generally to water heater appliances, and more particularly to methods for controlling water heater appliances.

### BACKGROUND OF THE INVENTION

Mixing valves in water heater appliances are generally used to increase the hot water capacity of hot water tanks of the water heater appliances. By increasing the temperature of the hot water in the hot water tank, and then mixing the hot water flow from the hot water tank with cold water in a mixing valve, the realized capacity of the hot water tank is increased.

However, improvements could be made to presently known methods for controlling such water heater appliances. For example, in many cases, the usage rate or demand for hot water from the water heater appliance varies over time. Thus, the increased energy consumption from increasing the temperature of the hot water in the hot water tank may not be desirable or necessary during times of relatively low use, whereas the increased realized capacity made possible by the increased temperature is desirable during times of relatively high use or high demand for hot water.

Accordingly, improved water heater appliances and methods for controlling water heater appliances are desired. In particular, water heater appliances configured for and methods of operating a water heater appliance that include automatically adjusting a temperature setpoint of the water heater based on demand would be advantageous, such as providing improved energy efficiency and performance of the water heater appliance.

### BRIEF DESCRIPTION OF THE INVENTION

Aspects and advantages of the invention will be set forth in part in the following description, or may be obvious from the description, or may be learned through practice of the invention.

In one exemplary embodiment, a method of operating a water heater appliance is provided. The water heater appliance includes a tank, a cold water inlet conduit extending into the tank, a heating element within the tank, a hot water conduit extending from the tank to a mixing valve, a mixed water conduit downstream of the mixing valve, and a user interface. The method includes receiving, from the user interface, a user value for a tank temperature setpoint. The method also includes determining a predicted demand for hot water. The method further includes adjusting the tank temperature setpoint based on the predicted demand for hot water.

In another exemplary embodiment, a water heater appliance is provided. The water heater appliance includes a tank. A cold water inlet conduit extends into the tank. The water heater appliance also includes a heating element within the tank and a hot water conduit extending from the tank to a mixing valve. The water heater appliance also includes a mixed water conduit downstream of the mixing valve. The water heater appliance further includes a user interface and a controller. The controller is in operative communication with the user interface and the heating element. The controller is configured for receiving a user value for a tank temperature setpoint from the user interface. The controller is also configured for determining a predicted demand for hot water. The controller is further configured for adjusting the tank temperature setpoint based on the predicted demand for hot water.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a front view of a water heater appliance in accordance with one or more exemplary embodiments of the present disclosure.

FIG. 2 is a schematic view of the water heater appliance of FIG. 1.

FIG. 3 is a flow chart illustrating a method operating a water heater appliance in accordance with one or more exemplary embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. As used herein, terms of approximation such as “generally,” “about,” or “approximately” include values within ten percent greater or less than the stated value. When used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

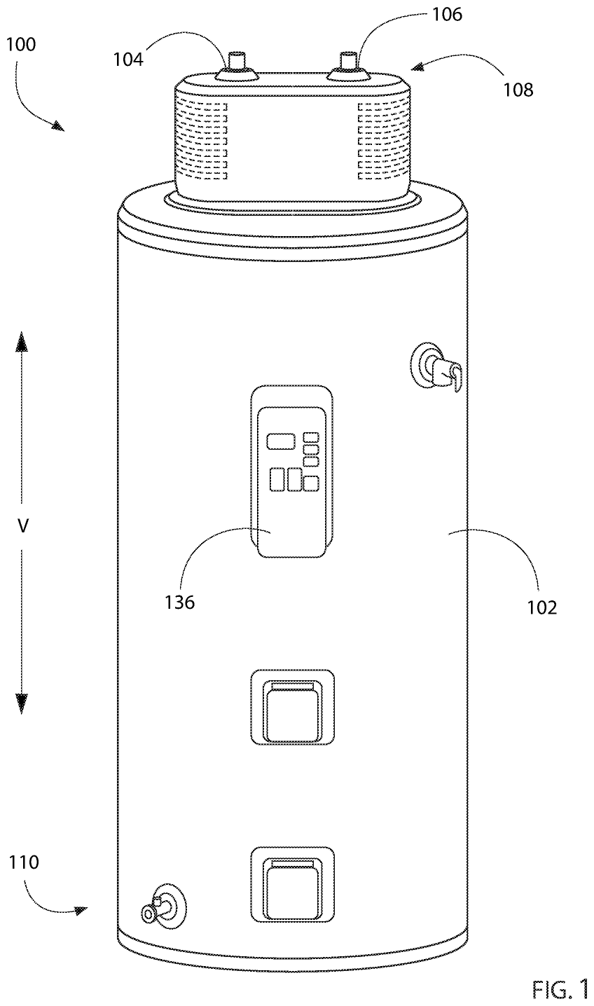

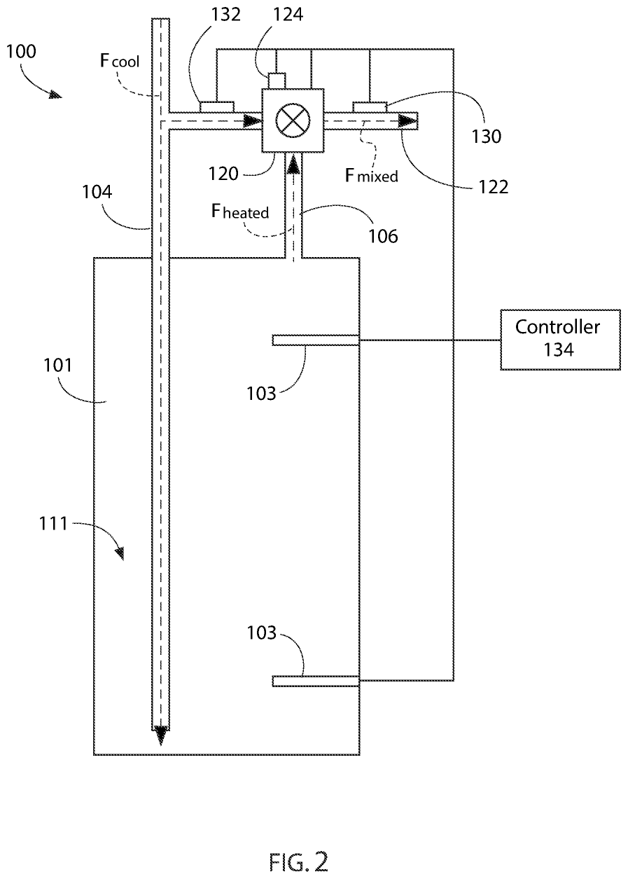

FIG. 1 illustrates an exemplary water heater appliance 100 according to an exemplary embodiment of the present subject matter. Water heater appliance 100 includes a casing 102. A tank 101 (FIG. 2) and heating elements 103 (FIG. 2) are positioned within casing 102 for heating water therein. Heating elements 103 may include a gas burner, a heat pump, an electric resistance element, a microwave element, an induction element, or any other suitable heating element or combination thereof. As will be understood by those skilled in the art and as used herein, the term “water” includes purified water and solutions or mixtures containing water and, e.g., elements (such as calcium, chlorine, and fluorine), salts, bacteria, nitrates, organics, and other chemical compounds or substances.

Water heater appliance 100 also includes a cold water conduit 104 and a hot water conduit 106 that are both in fluid communication with a chamber 111 (FIG. 2) defined by tank 101. As an example, cold water from a water source, e.g., a municipal water supply or a well, can enter water heater appliance 100 through cold water conduit 104 (shown schematically with arrow labeled F_{cool} in FIG. 2). From cold water conduit 104, such cold water can enter chamber 111 of tank 101 wherein it is heated with heating elements 103 to generate heated water. Such heated water can exit water heater appliance 100 at hot water conduit 106 and, e.g., be supplied to a bath, shower, sink, or any other suitable fixture.

Water heater appliance 100 extends longitudinally between a top portion 108 (FIG. 1) and a bottom portion 110 along a vertical direction V. Thus, water heater appliance 100 is generally vertically oriented. Water heater appliance 100 can be leveled, e.g., such that casing 102 is plumb in the vertical direction V, in order to facilitate proper operation of water heater appliance 100. It should be understood that water heater appliance 100 is provided by way of example only and that the present subject matter may be used with any suitable water heater appliance.

FIG. 2 provides a schematic view of certain components of water heater appliance 100. As may be seen in FIG. 2, water heater appliance 100 includes a mixing valve 120 and a mixed water conduit 122. Mixing valve 120 is in fluid communication with cold water conduit 104, hot water conduit 106, and mixed water conduit 122. As discussed in greater detail below, mixing valve 120 is configured for selectively directing water from cold water conduit 104 and hot water conduit 106 into mixed water conduit 122 in order to regulate a temperature of water within mixed water conduit 122.

As an example, mixing valve 120 can selectively adjust between a first position and a second position. In the first position, mixing valve 120 can permit a first flow rate of relatively cool water from cold water conduit 104 (shown schematically with arrow labeled F_{cool} in FIG. 2) into mixed water conduit 122 and mixing valve 120 can also permit a first flow rate of relatively hot water from hot water conduit 106 (shown schematically with arrow labeled F_{heated} in FIG. 2) into mixed water conduit 122. In such a manner, water within mixed water conduit 122 (shown schematically with arrow labeled F_{mixed} in FIG. 2) can have a first particular temperature when mixing valve 120 is in the first position. Similarly, mixing valve 120 can permit a second flow rate of relatively cool water from cold water conduit 104 into mixed water conduit 122 and mixing valve 120 can also permit a second flow rate of relatively hot water from hot water conduit 106 into mixed water conduit 122 in the second position. The first and second flow rates of the relatively cool water and relatively hot water are different such that water within mixed water conduit 122 can have a second particular temperature that is different from the first particular temperature when mixing valve 120 is in the second position. In such a manner, mixing valve 120 can regulate the temperature of water within mixed water conduit 122 and adjust the temperature of water within mixed water conduit 122 between the first and second particular temperatures.

It should be understood that, in certain exemplary embodiments, mixing valve 120 is adjustable between more positions than the first and second positions. In particular, mixing valve 120 may be adjustable between any suitable number of positions in alternative exemplary embodiments. For example, mixing valve 120 may be infinitely adjustable in order to permit fine-tuning of the temperature of water within mixed water conduit 122.

Water heater appliance 100 also includes a position sensor 124. Position sensor 124 is configured for determining a position of mixing valve 120. Position sensor 124 can monitor the position of mixing valve 120 in order to assist with regulating the temperature of water within mixed water conduit 122. For example, position sensor 124 can determine when mixing valve 120 is in the first position or the second position in order to ensure that mixing valve 120 is properly or suitably positioned depending upon the temperature of water within mixed water conduit 122 desired or selected. Thus, position sensor 124 can provide feedback regarding the status or position of mixing valve 120.

Water heater appliance 100 also includes a mixed water conduit temperature sensor or first temperature sensor 130 and a cold water conduit temperature sensor or second temperature sensor 132. First temperature sensor 130 is positioned on or proximate to mixed water conduit 122 and is configured for measuring a temperature of water within mixed water conduit 122. First temperature sensor 130 is also positioned downstream of mixing valve 120. Second temperature sensor 132 is positioned on or proximate to cold water conduit 104 and is configured for measuring a temperature of water within cold water conduit 104. Second temperature sensor 132 is positioned upstream of mixing valve 120. In certain exemplary embodiments, first temperature sensor 130 and/or second temperature sensor 132 may be positioned proximate or adjacent mixing valve 120.

Water heater appliance 100 further includes a controller 134 that is configured for regulating operation of water heater appliance 100. Controller 134 is in, e.g., operative, communication with heating elements 103, mixing valve 120, position sensor 124, and first and second temperature sensors 130 and 132. Thus, controller 134 can selectively activate heating elements 103 in order to heat water within chamber 111 of tank 101. Similarly, controller 134 can selectively operate mixing valve 120 in order to adjust a position of mixing valve 120 and regulate a temperature of water within mixed water conduit 122.

Controller 134 includes memory and one or more processing devices such as microprocessors, CPUs or the like, such as general or special purpose microprocessors operable to execute programming instructions or micro-control code associated with operation of water heater appliance 100. The memory can represent random access memory such as DRAM, or read only memory such as ROM or FLASH. The processor executes programming instructions stored in the memory. The memory can be a separate component from the processor or can be included onboard within the processor. Alternatively, controller 134 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 134 can be positioned at a variety of locations. In the exemplary embodiment shown in FIG. 1, controller 134 is positioned within water heater appliance 100, e.g., as an integral component of water heater appliance 100. In alternative exemplary embodiments, controller 134 may be positioned away from water heater appliance 100 and communicate with water heater appliance 100 over a wireless connection, e.g., over the internet or via the cloud, or any other suitable connection, such as a wired connection.

The controller 134 may also include or be coupled to a user interface 136 (FIG. 1). The user interface 136 may comprise any suitable control or display that will allow a user to program, set, and adjust the functions and settings of the water heater appliance 100, as are generally described herein. In some exemplary embodiments, the user interface 136 may comprise a display interface, such as a touch screen display. In some exemplary embodiments, the user interface 136 may also or instead include mechanical buttons or switches for manipulating and programming the settings of the water heater appliance 100, including, for example, the setpoint temperature. In some exemplary embodiments, the user interface 136 may comprise or be part of a control panel for the water heater appliance 100. The user interface 136 may also be located remotely from the water heater appliance 100, and may be accessible through a computing device that is remote from the water heater appliance 100 or through a web-based interface.

Controller 134 can operate heating elements 103 to heat water within chamber 111 of tank 101. As an example, a user can select or establish a setpoint temperature for water within chamber 111 of tank 101, e.g., via the user interface 136 as described above, or the setpoint temperature for water within chamber 111 of tank 101 may be a default value. Based upon the setpoint temperature for water within chamber 111 of tank 101, controller 134 can selectively activate heating elements 103 in order to heat water within chamber 111 of tank 101 to the setpoint temperature for water within chamber 111 of tank 101. The setpoint temperature for water within chamber 111 of tank 101 can be any suitable temperature. For example, the setpoint temperature for water within chamber 111 of tank 101 may be between about one hundred and forty degrees Fahrenheit and about one hundred and eighty degrees Fahrenheit.

Controller 134 can also operate mixing valve 120 to regulate the temperature of water within mixed water conduit 122. For example, controller 134 can adjust the position of mixing valve 120 in order to regulate the temperature of water within mixed water conduit 122. As an example, a user can select or establish a setpoint temperature of mixing valve 120, or the setpoint temperature of mixing valve 120 may be a default value. Based upon the setpoint temperature of mixing valve 120, controller 134 can adjust the position of mixing valve 120 in order to change or tweak a ratio of relatively cool water flowing into mixed water conduit 122 from cold water conduit 104 and relatively hot water flowing into mixed water conduit 122 from hot water conduit 106. In such a manner, controller 134 can regulate the temperature of water within mixed water conduit 122.

The setpoint temperature of mixing valve 120 can be any suitable temperature. For example, the setpoint temperature of mixing valve 120 may be between about one hundred degrees Fahrenheit and about one hundred and twenty degrees Fahrenheit. In particular, the setpoint temperature of mixing valve 120 may be selected such that the setpoint temperature of mixing valve 120 is less than the setpoint temperature for water within chamber 111 of tank 101. In such a manner, mixing valve 120 can utilize water from cold water conduit 104 and hot water conduit 106 to regulate the temperature of water within mixed water conduit 122.

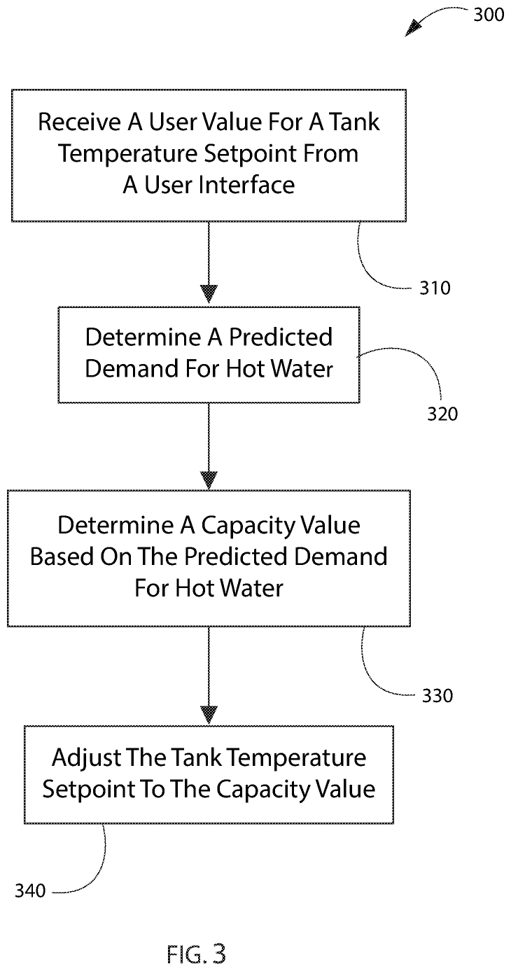

FIG. 3 illustrates a method 300 for operating a water heater appliance according to an exemplary embodiment of the present subject matter. Method 300 can be used to operate any suitable water heater appliance. For example, method 300 may be utilized to operate water heater appliance 100 (FIG. 1). Controller 134 of water heater appliance 100 may be programmed to implement method 300, e.g., controller 134 is capable of and may be operable to perform any methods and associated method steps as disclosed herein. In some embodiments, the controller 134 may perform method steps in combination with one or more remote computing devices, such as a remote database or remote processor. In such embodiments, the controller 134 may communicate with such remote computing device or devices via the internet or the cloud, among other possible communications means. For example, some embodiments of the methods disclosed herein may include distributed computing whereby certain steps or calculations/determinations are performed locally, e.g., by the controller 134 onboard the water heater appliance 100, while other steps or calculations/determinations are performed by a remote computing device with which the controller 134 communicates via the internet. As illustrated in FIG. 3, the method 300 may include a step 310 of receiving a user value for a tank temperature setpoint, e.g., from a user interface of the water heater appliance. The method 300 may also include a step 320 of determining a predicted demand for hot water. In some embodiments, the method 300 may then include a step 330 of determining a capacity value based on the predicted demand for hot water and a step 340 of adjusting the tank temperature setpoint based on the predicted demand for hot water, such as adjusting the tank temperature setpoint to the capacity value. For example, when the predicted demand is high, the capacity value may be a higher temperature than the user value for the tank temperature setpoint, thereby permitting the water heater appliance to provide a larger effective capacity to meet the higher demand. As another example, when the predicted demand is low, the capacity value may be a lower temperature than the user value for the tank temperature setpoint, thereby permitting the water heater appliance to use less energy while still meeting the lower demand for hot water.

In some embodiments, determining the predicted demand may include calculating a volume of hot water consumed based on a duty cycle of the heating element and developing a usage profile based on the calculated volume of hot water. For example, the volume of hot water consumed may be calculated based on the duty cycle and in particular based on the on time of the heating element. In some embodiments, the calculation of the volume of hot water consumed may also be based on the tank temperature setpoint. For example, the volume of hot water consumed may be calculated based on the tank temperature setpoint and how long the heating element has to run to achieve the tank temperature setpoint. Additionally, the water heater appliance may include more than one heating element, such as an upper heating element and a lower heating element, e.g., as illustrated in FIG. 2. In such embodiments which include an upper heating element, e.g., a heating element which is relatively closer to the hot water conduit 106, the duty cycle on which the calculated volume of water is based may be the on time of the upper heating element and/or may include which heating element (or both heating elements) is or are activated. In some embodiments, the calculation of the volume of hot water consumed may also be based on the incoming, e.g., cold, water temperature.

In at least some embodiments, methods of operating the water heater appliance may also include setting the tank temperature setpoint to the user value before determining the predicted demand for hot water. For example, the user value may be a default value for the tank temperature setpoint and the method may only include overriding the user value or automatically adjusting the tank temperature setpoint after the water heater appliance has been operated for a long enough time period to develop a capacity forecast on which the predicted demand for hot water may be based. The capacity forecast may be based on a usage profile which reflects usage patterns or changes in the demand for hot water from the water heater appliance over time, such as from day to day or at different times of day, different days of the week, etc. For example, the usage profile may include a predicted demand for hot water based on the day of the week, the time of day, and/or other factors. Thus, in some embodiments, methods of operating the water heater appliance may include tracking the volume of hot water consumed on an hourly basis throughout each day for at least seven consecutive days, where the usage profile thereby includes a daily hot water usage for each day of the week, and may also include multiple hot water usages for various periods during a single day, such as morning and evening hot water usage or hourly hot water usage, etc. The hot water usage may be expressed in volume, e.g., in gallons. In such embodiments, the method may further include calculating a capacity forecast, such as an hourly capacity forecast, for each day of the week based on the usage profile.

In some embodiments, the step of adjusting the tank temperature setpoint to the capacity value may be performed when one or more users are detected proximate to the water heater appliance, e.g., when a main user is at home or when a number of users equal to or greater than a predetermined limit is at home. For example, detecting when the user or users is or are present may be based on geo-fencing. Thus, in some embodiments, the step of adjusting the tank temperature setpoint to the capacity value may be performed in response to detecting a remote user interface device within a predefined proximity of the water heater appliance. The remote user interface device may be, e.g., a smart phone, smart watch, or any other suitable user interface device.

In some embodiments, the method may also include providing a user notification of the capacity value. For example, the capacity value may be presented to the user as a suggested user value. As another example, the user notification may be provided after adjusting the tank temperature setpoint to the capacity value and the user notification may be or include an indication that the tank temperature setpoint has been automatically adjusted to a value that is different from the user value. The user notification may be provided, in some example embodiments, on a display of the user interface 136 or on a display of a control panel which includes the user interface 136. In some embodiments, the user notification may also or instead be provided on a remote user interface device, e.g., smart phone, etc., as mentioned above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of operating a water heater appliance, the water heater appliance comprising a tank, a cold water inlet conduit extending into the tank, a heating element within the tank, a hot water conduit extending from the tank to a mixing valve, a mixed water conduit downstream of the mixing valve, and a user interface, the method comprising:
receiving, from the user interface, a user value for a tank temperature setpoint;
determining a predicted demand for hot water by calculating a volume of hot water consumed based on a duty cycle of the heating element and developing a usage profile based on the calculated volume of hot water, wherein developing the usage profile comprises tracking the volume of hot water consumed on an hourly basis for at least seven consecutive days, and wherein determining the predicted demand for hot water comprises calculating an hourly capacity forecast for each day of the week based on the usage profile; and
adjusting the tank temperature setpoint based on the predicted demand for hot water at a current time of day during a current day of the week.

2. The method of claim 1, further comprising setting the tank temperature setpoint to the user value before determining the predicted demand for hot water.

3. The method of claim 1, further comprising determining a capacity value based on the predicted demand for hot water, wherein adjusting the tank temperature setpoint based on the predicted demand for hot water comprises adjusting the tank temperature setpoint to the capacity value, and wherein the capacity value is different from the user value.

4. The method of claim 3, wherein the capacity value is greater than the user value when the predicted demand is high.

5. The method of claim 3, wherein the capacity value is less than the user value when the predicted demand is low.

6. The method of claim 3, further comprising providing a user notification of the capacity value.

7. The method of claim 3, wherein the step of adjusting the tank temperature setpoint to the capacity value is performed in response to detecting a remote user interface device within a predefined proximity of the water heater appliance.

8. (canceled)

9. (canceled)

10. The method of claim 1, wherein the volume of hot water consumed is calculated based on the tank temperature setpoint.

11. A water heater appliance, comprising:
a tank;
a cold water inlet conduit extending into the tank;
a heating element within the tank;
a hot water conduit extending from the tank to a mixing valve;
a mixed water conduit downstream of the mixing valve;
a user interface; and
a controller in operative communication with the user interface and the heating element, the controller configured for:
receiving, from the user interface, a user value for a tank temperature setpoint;
determining a predicted demand for hot water, by calculating a volume of hot water consumed based on a duty cycle of the heating element and developing a usage profile based on the calculated volume of hot water, wherein developing the usage profile comprises tracking the volume of hot water consumed on an hourly basis for at least seven consecutive days, and by calculating an hourly capacity forecast for each day of the week based on the usage profile; and
adjusting the tank temperature setpoint based on the predicted demand for hot water at a current time of day during a current day of the week.

12. The water heater appliance of claim 11, wherein the controller is further configured for setting the tank temperature setpoint to the user value before determining the predicted demand for hot water.

13. The water heater appliance of claim 11, wherein the controller is further configured for determining a capacity value based on the predicted demand for hot water, wherein adjusting the tank temperature setpoint based on the predicted demand for hot water comprises adjusting the tank temperature setpoint to the capacity value, and wherein the capacity value is different from the user value.

14. The water heater appliance of claim 13, wherein the capacity value is greater than the user value when the predicted demand is high.

15. The water heater appliance of claim 13, wherein the capacity value is less than the user value when the predicted demand is low.

16. The water heater appliance of claim 13, wherein the controller is further configured for providing a user notification of the capacity value.

17. The water heater appliance of claim 13, wherein the step of adjusting the tank temperature setpoint to the capacity value is performed in response to detecting a remote user interface device within a predefined proximity of the water heater appliance.

18. (canceled)

19. (canceled)

20. The water heater appliance of claim 11, wherein the controller is configured for calculating the volume of hot water consumed based on the tank temperature setpoint.

21. A method of operating a water heater appliance, the water heater appliance comprising a tank, a cold water inlet conduit extending into the tank, a heating element within the tank, a hot water conduit extending from the tank to a mixing valve, a mixed water conduit downstream of the mixing valve, and a user interface, the method comprising:
receiving, from the user interface, a user value for a tank temperature setpoint;
calculating a volume of hot water consumed based on a duty cycle of the heating element;
tracking volume of hot water consumed on an hourly basis for at least seven consecutive days;
developing a usage profile for a week from the tracked hot water consumption, the usage profile for the week comprising a plurality of predicted hot water demand values for each hour of each day of the week; and
adjusting the tank temperature setpoint based on a predicted hot water demand value from the usage profile for the week that corresponds to a current hour and a current day of the week.

22. The method of claim 21, wherein the step of adjusting the tank temperature setpoint comprises adjusting the tank temperature setpoint to a capacity value corresponding to the predicted hot water demand value for the current hour and the current day of the week, and wherein the capacity value is different from the user value.

23. The method of claim 22, further comprising providing a user notification of the capacity value.

24. The method of claim 22, wherein the step of adjusting the tank temperature setpoint to the capacity value is performed in response to detecting a remote user interface device within a predefined proximity of the water heater appliance.
